(19) United States
(12) Patent Application Publication
(10) Pub. No.: US 2005/0109982 A1
(43) Pub. Date: May 26, 2005

(54) Agent and method for removing organic chlorine compounds

(75) Inventors: Keita Yura, Kobe-shi (JP); Masaaki Matsubara, Kobe-shi (JP); Yasuko Yakou, Kobe-shi (JP); Hitoshi Sakuma, Takasago-shi (JP); Yoshikazu Seki, Takasago-shi (JP); Satoshi Furuta, Takasago-shi (JP); Koji Yamamoto, Kobe-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 10/971,307

(22) Filed: Oct. 25, 2004

(30) Foreign Application Priority Data
Nov. 7, 2003 (JP) 2003-378134

(51) Int. Cl. C02F 1/70

(52) U.S. Cl. 252/188.1

(57) ABSTRACT

An agent for removing organic chlorine compounds which is composed of (A) an iron powder having a BET specific surface area of from 0.010 to 3 m²/g, and (B1) a powder of at least one species of metal selected from the group VIII elements (excluding Fe) in the periodic table, and/or (B2) a porous substance in powder form supporting said metal. If the agent is composed of (A) and (B1), the amount of (B1) is 0.01 to 10 parts by mass for 100 parts by mass of (A). If the agent is composed of (A) and (B2), the amount of (B2) is 0.0001 to 10 parts by mass for 100 parts by mass of (A). This agent is capable of removing organic chlorine compounds efficiently.

### BACKGROUND OF THE INVENTION

1. Field of the Invention

The present invention relates a technique for clarifying soil and/or groundwater contaminated with organic chlorine compounds.

2. Description of the Related Art

Chlorinated organic solvents find general use as a cleaning agent in the field (such as semiconductors and precision parts), where final and intermediate products are required to be extremely clean, on account of their high degreasing power. They also find use as a solvent for dry cleaning. Since these chlorinated organic solvents are one of the pollutants that attack the ozone layer, their production and use have been restricted by the Montreal Protocol, and their consumption is decreasing now. However, it has recently been revealed that they contaminated soil and groundwater in-the past when they had been inadequately used in large amounts. This contamination is now a serious social problem and the present or past landowners are accused of contamination due to inadequate use and treatment. Of chlorinated organic solvents, trichloroethylene and tetrachloroethylene were used in large quantities, and they are known to be carcinogenic and there is some fear for their release into the atmosphere. Measures for their early removal and clarification are in urgent need to ensure the safety of residents living in the neighborhood of contaminated land or in the area downstream the groundwater flowing through the contaminated land.

In actual, however, clarification progresses only slowly because it is difficult to find a person in charge (due to past loose regulations and a long time before revelation) and clarification costs much. There is a strong demand for development of an economical, effective method for clarification in parallel to legislation (Soil Pollution Control Act, enforced February 2003).

There have been proposed several methods for clarifying contaminated soil and groundwater in situ. They include soil flushing, soil washing, soil gas extraction, pumping aeration, and biological decomposition.

Soil flushing is intended to extract contaminants by injecting a cleaning solution into soil. Although it is effective for readily percolating soil, there is a possibility that the cleaning solution itself becomes a contaminant.

Soil gas extraction is intended to separate volatile contaminants from soil through wells drilled therein. Although it is effective for volatile contaminants, its application is sometimes limited by the geological condition and the kind and distribution of contaminants.

Pumping aeration is intended to pump up groundwater and expose it to air, thereby separating volatile contaminants from groundwater. It readily separates volatile contaminants but it is less effective than soil gas extraction.

Biological decomposition is intended to decompose contaminants with the help of microbes. Although it works with a small amount of energy, its application is sometimes limited by the kind of contaminants and the weather condition of contaminated land. The above-mentioned methods are simple in principle but they have problems with cost and safety. None of them seems useful to clean contaminated soil adequately.

There is a promising technique for dechlorination with an iron powder that is capable of reduction. It is applicable particularly to organic chlorine compounds (organic chlorides) among various contaminants to be removed. It is inexpensive and safe and is expected to be put to practical use. On the other hand, there are several methods for decomposition of organic compounds, and combustion is one of simple methods among them so long as combustion is allowed outside the spot. The combustion method is intended to decompose by oxidation organic compounds into carbon dioxide and water, thereby making them innocuous. It seems possible to apply the combustion method to organic chlorine compounds. However, it has been pointed out from the thermodynamic point of view that removal of chlorine by reduction with an iron powder would proceed even at normal temperature. So, investigations are being made into means of rendering contaminants harmless by using an iron powder as a reducing agent. Dechlorination of organic chlorides by reduction reaction seems to be an advantageous method for treatment of groundwater in the anaerobic condition isolated from the atmosphere.

The dechlorination reaction induced by an iron powder is elucidated by the local cell reaction. (Non-patent document 1) Elucidation according to this document is as follows. Upon adsorption of an organic chlorine compound on the surface of iron powder, anode polarization and cathode polarization take place due to difference between the condition of metal and the condition of organic chlorine compound (environment). This polarization causes electrons to flow. In other words, iron at the anode turns into iron ions, thereby releasing electrons (Fe→Fe²⁺+2^{e-}), and the cathode utilizes these electrons to bring about the reduction reaction for dechlorination.

According to the theory of local cell reaction, it is necessary to increase the chances that iron powder comes into contact with organic chlorine compounds (or the chances that local cells occur). One way to achieve this object is to increase the surface area of iron powder. This is accomplished by reducing the particle diameter of iron powder, causing small iron particles to adhere to large iron particles by sintering, or making iron powder porous. (Patent documents 1 to 3) For the efficient local cell reaction, attempts are being made to cause Cu, Zn, Ni, or Ti to deposit on the surface of iron powder or to be alloyed with iron. (Patent documents 3 to 6) According to Patent document 3, how the local cell reaction is accelerated by Cu is elucidated as follows. The system involves several kinds of local cells and oxidation reduction reactions for ion migration because of difference in standard electrode potential among metallic iron, ferrous ions, metallic copper, and cuprous ions. And, this ion migration helps iron to decompose organic halogen compounds. Patent document 4 mentions an iron alloy because an iron alloy has a standard electrode potential within a certain range. Patent document 5 regards Ni or Cu as functioning as the cathode. Patent document 6 mentions an iron powder supporting Ti on its surface on the ground that a local cell is formed between iron and Ti and this local cell enhances the reducing action of iron powder (or the ability to give electrons to organic halogen compounds), thereby promoting dehalogenation from organic halogen compounds.

(Non-Patent Document 1)

“Treatment of groundwater contaminated with organic chlorine compounds—Technique for treatment with active carbon carrying metallic iron at low temperatures”, by Tetsuo Yazaki, PPM, issued by The Nippon Kogyo Shinbun, 1995, vol. 26, No. 5, pp. 64-70.

(Patent Document 1)

Japanese Patent Laid-open No. 2001-198567

(Patent Document 2)

Japanese Patent Laid-open No. 2002-167602

(Patent Document 3)

Japanese Patent Laid-open No. 2002-69425

(Patent Document 4)

Japanese Patent Laid-open No. Hei-11-253926

(Patent Document 5)

Japanese Patent Laid-open No. 2002-161263

(Patent Document 6)

Japanese Patent Laid-open No. 2003-80074

### OBJECT AND SUMMARY OF THE INVENTION

The present invention was completed in view of the foregoing. It is an object of the present invention to provide a technique for efficiently treating organic chlorine compounds.

As mentioned above, the reaction for removal (decomposition) of organic chlorine compounds by iron powder is elucidated by the local cell reaction. The mechanism of local cell requires conduction between iron and another element such as Cu, Zn, Ni, and Ti. This means that iron should be in contact with (or integral with) another element. Therefore, prior art technologies achieve this object by alloying iron with another element or by causing another elements to deposit on the surface of iron.

However, the present inventors conceived of a mechanism of non-local cell type, which is different from the above-mentioned one. It involves reactions that proceed in three stages as follows.

(1) Iron powder decays to liberate electrons.
Fe→Fe²⁺+2^{e-}

(2) Electrons react with water to give hydrogen.
2H₂O+2^{e-}→2OH⁻+H₂↑

(3) Hydrogen reacts with organic chlorine compounds to eliminate chlorine ions therefrom. In this way, dechlorination from organic chlorine compounds is completed.

In the reactions mentioned above, iron works merely to evolve hydrogen and hence the final dechlorination reaction does not need to take place on the surface of iron powder. In other words, it is not always necessary for iron to be in close contact (through alloying or surface deposition) with any other element involved in dechlorination.

As the result of their extensive investigations, the present inventors found that an iron powder (in the form of mixture with nickel powder) designed according to the nonlocal cell theory removes (or decomposes) organic chlorine compounds more efficiently than an iron powder (in the form of Fe—Ni alloy) designed according to the local cell theory. This finding led to the present invention.

The present invention is directed to an agent for removing organic chlorine compounds which comprises mixed together:
(A) an iron powder having a BET specific surface area of from 0.010 to 3 m²/g, and
(B1) a powder of at least one species of metal selected from the group VIII elements (excluding Fe) in the periodic table, and/or
(B2) a porous substance in powder form supporting said metal.

In the case where the agent for removing organic chlorine compounds comprises the constituents (A) and (B1), 100 parts by mass of the constituent (A) is usually incorporated with 0.01 to 10 parts by mass of the constituent (B1).

In the case where the agent for removing organic chlorine compounds comprises the constituents (A) and (B2), 100 parts by mass of the constituent (A) is usually incorporated with 0.0001 to 10 parts by mass of the constituent (B2).

The constituent (B2) usually contains the group VIII elements (excluding Fe) in an amount of 0.01 to 30 mass %.

The constituent (B1) has a BET specific surface area ranging from 0.05 to 4 m²/g.

The constituent (B2) has a BET specific surface area ranging from 4 to 1000 m²/g.

The porous substance as the constituent (B2) is one or more members selected from alumina, hydrotalcite, allophane, aluminosilicate, zeolite, activated clay, mica, silica, talc, diatomaceous earth, and active carbon.

The constituent (B1) or (B2) should preferably be formed from any of Ni, Ru, Rh, Pd, and Pt.

The iron powder as the constituent (A) should preferably contain oxygen in an amount no more than 5 mass %.

The agent for removing organic chlorine compounds does not necessarily need to be a uniform mixture of the iron powder [as the constituent (A)] and/or the powder [the metal powder as the constituent (B1) and the metal-supporting porous powder as the constituent (B2)].

The agent for removing organic chlorine compounds, which accords with the present invention, is useful for cleaning soil and/or groundwater which has been contaminated with organic chlorine compounds. For the purpose of decomposition and removal of organic chlorine compounds in soil and/or groundwater, it is mixed with 2 to 100 times as much soil and the resulting mixture is brought into contact with contaminated soil or groundwater. The mixing of the agent with soil should preferably be accomplished in such a way that the separation index K defined below takes a value of 7 to 15 for the iron powder [as the constituent (A)] and the powder [as the constituents (B1) and/or (B2)].
K=−log₁₀ [4πR_{A}²/{(V_{A}/V_{B1})+(V_{A}/V_{B2})}]
(where, R_{A} denotes the radius (m) of the soil regarded as a sphere with which one grain of the iron powder (A) is involved;
V_{A} denotes the volume (m³) of the soil with which one grain of the iron powder (A) is involved;
V_{B1} denotes the volume (m³) of the soil with which one grain of the metal powder (B1) is involved; and
V_{B2} denotes the volume (m³) of the soil with which one grain of the metal powder (B2) is involved.)

Incidentally, the R_{A} is obtained from the formula below.
R_{A}={3V_{A}/(4π)}^{1/3}
V_{A}, V_{B1}, and V_{B2} mentioned above are calculated from the following formulas.
V_{A}=(100/d)/{(x/ρA)/(πD_{A}³/6)}
V_{B1}=(100/d)/{(yB1/ρB1)/(πD_{B1}³/6)}
V_{B2}=(100/d)/{(yB2/ρB2)/(πD_{B2}³/6)}
(where, d denotes the apparent density (ton/m³) of soil; x denotes the amount (ton) of the iron powder (A) used for 100 tons of soil;
ρA denotes the density (ton/m³) of the iron powder (A);
D_{A} denotes the particle diameter (m) of the iron powder (A);
yB1 denotes the amount (ton) of the metal powder (B1) used for 100 tons of soil;
ρB1 denotes the density (ton/m³) of the metal powder (B1);
D_{B1} denotes the particle diameter (m) of the metal powder (B1);
yB2 denotes the amount (ton) of the supporting powder (B2) used for 100 tons of soil;
ρB2 denotes the density (ton/m³) of the supporting powder (B2); and
D_{B2} denotes the particle diameter (m) of the supporting powder (B2).

The values of d, ρA, ρB1, and ρB2 can be obtained by direct measurements of soil and powders. The value of D_{B2} can be obtained directly by measurement of the supporting powder B2 with an apparatus for measuring particle size distribution by laser diffraction. The values of D_{A} and D_{B1} can be obtained from the formula below by measurement of the BET specific surface area of the respective powders. The values of x, yB1, and yB2 are adjusted so that the separation factor K takes a value from 7 to 15.
D_{A}=6/(ρA σA)
D_{B1}=6/(ρB1σB1)
(where, σA denotes the BET specific surface area (m²/ton) of the iron powder (A), and δB1 denotes the BET specific surface area (m²/ton) of the metal powder (B1).)

If the agent for removing organic chlorine compounds is a mixture (C) of the iron powder (A) and the powder [the metal powder (B1) and/or the supporting powder (B2)], it may be used in a more effective way as follows. The first step is to partly divide the region (or land) where ground-water is flowing into two or more layers in the vertical direction. The second step is to mix 1-50 parts by mass of the iron powder with 100 parts by mass of soil in at least one layer under the second layer. The third step is to mix 1-50 parts by mass of the agent for removing organic chlorine compounds with 100 parts by mass of soil in at least one layer above the layer to which the iron powder has been added. It is particularly desirable to form these layers alternately, such that 1-50 parts by mass of the iron powder is mixed with 100 parts by mass of soil in one layer and 1-50 parts by mass of the agent for removing organic chlorine compounds is mixed with 100 parts by mass of soil in another layer. If the agent for removing organic chlorine compounds is composed of the iron powder (A) and the powder [the metal powder (B1) and/or the supporting powder (B2)] but they are not mixed together, it may be used in a more effective way as follows. The first step is to partly divide the region (or land) where groundwater is flowing into two or more layers in the vertical direction. The second step is to mix the iron powder (A) with soil in at least one layer under the second layer. The third step is to mix the powder [the metal powder (B1) and/or the supporting powder (B2)] with soil in at least one layer above the layer to which the iron powder has been added.

The agent for removing organic chlorine compound, which accords with the present invention, is composed of an iron powder (A) and a specific metal powder (to function as a catalyst for hydrogenation), which is supported or not supported on a carrier. It removes (or decomposes) organic chlorine compounds by reactions different from the local cell reaction. It removes (or decomposes) organic chlorine compounds more effectively than a plain iron powder designed based on the theory of local cell reaction. Moreover, it obviates the necessity of keeping another metal in contact with the surface of iron powder. This eliminates the process for alloying or deposition (to keep another metal in contact with the iron powder). This in turn facilitates stable production without complex quality control.

### BRIEF DESCRIPTION OF THE DRAWINGS

FIG. 1 is a schematic diagram showing one example of the usage of the agent for removing organic chlorine compounds, which accords with the present invention.

FIG. 2 is a schematic diagram showing another example of the usage of the agent for removing organic chlorine compounds, which accords with the present invention.

FIG. 3 is a graph showing the efficiency of removal by various kinds of agents for removing organic chlorine compounds.

FIG. 4 is a graph showing the efficiency of removal which is achieved when various kinds of agents for removing organic chlorine compounds are mixed with soil.

### DESCRIPTION OF THE PREFERRED EMBODIMENTS

According to the present invention, the agent for removing organic chlorine compounds is a mixture of an iron powder (A) and a powder of other metal than iron (B). The mixture is formed in such a way that the iron powder (A) is not in close contact with (or is not integral with) the powder (B). Therefore, when it is applied to soil, the powder (B) should not support the action of decomposition of organic chlorine compounds by the iron powder (A) according to the local cell theory. In actual, however, the powder mixture decomposes organic chlorine compounds more efficiently than the powder in which the iron powder is in close contact with another metal by alloying or surface deposition. A probable reason for this is that the decomposition of organic chlorine compounds is by the mechanism different from that of local cell or that the mechanism different from that of local cell is more active than the mechanism of local cell.

In other words, the present inventors conceived of a reaction mechanism consisting of the following three steps as mentioned above.
(1) The iron powder (A) decays.
(2) The iron powder (A) evolves hydrogen.
(3) The powder (B) brings about dechlorination with the help of hydrogen.
   What is important in this reaction mechanism is to increase the amount of hydrogen evolved by the iron powder (A). Moreover, even though there is a sufficient evolution of hydrogen, it is important to adequately select the powder (B) capable of efficient dechlorination.

One way to increase the amount of hydrogen evolved by the iron powder (A) it to cause the iron powder (A) to come into contact with groundwater as efficiently as possible. To be concrete, the iron powder (A) should have a BET specific surface area not smaller than 0.010 m²/g, preferably not smaller than 0.05 m²/g, and more preferably not smaller than 0.1 m²/g. (A BET specific surface area is determined from the amount of nitrogen (in the form of monomolecular layer) adsorbed onto the surface of a sample at a liquid nitrogen temperature.) The larger is the BET specific surface area, the more the iron powder evolves hydrogen per unit time and the more the decomposition of organic chlorine compounds takes place. However, this is not true in the in-situ treatment of organic chlorine compounds. The flow of groundwater is very slow and hence untreated organic chlorine compounds contained in the groundwater gradually reach the place where there exists the agent for removing organic chlorine compounds. Therefore, hydrogen is wasted if it is evolved excessively fast by the iron powder. Moreover, the iron powder is deactivated in a short period of time. This results in a decrease in the amount of the organic chlorine compounds that can be treated. The present invention requires that the evolution of hydrogen remains constant over a long period of time. Consequently, the iron powder should have a BET specific surface area not more than 3 m²/g, preferably not more than 2 m²/g, and more preferably not more than 1 m²/g, and particularly not more than 0.5 m²/g.

So long as the iron powder (A) has a sufficiently large BET specific surface area, it will evolve as much hydrogen as necessary. However, in the case where the iron powder (A) is used in a comparatively small amount, it is desirable that the iron powder (A) is not oxidized as far as possible. Therefore, the content of oxygen in the iron powder (A) should be no more than 5 mass %, preferably no more than 3 mass %, and more preferably no more than 2 mass %.

Incidentally, the oxygen content can be determined with an infrared detector which detects oxygen liberated from a solid sample upon pyrolysis. This method is commonly used for analysis of metallic materials and functional ceramics.

The powder (B) should be formed from the group VIII elements (excluding iron) in the periodic table, preferably Ni, Ru, Rh, Pd, and Pt, which efficiently hydrogenate organic chlorine compounds. These metals are known to be hydrogenating catalysts. (They may occasionally be referred to as hydrogenating catalyst metal hereinafter.) When hydrogen atoms come into contact with the hydrogenating catalyst metal, individual hydrogen atoms are adsorbed to the metal atoms on the metal surface (through dissociation adsorption), so that the hydrogen atoms can move freely on the metal surface. It is considered that the activated hydrogen readily reacts with organic chlorine compounds coming into contact with the catalyst surface, and this reaction brings about dechlorination. Preferred examples of the hydrogenating catalyst metal include Ni, Pd, and Pt. They excel in the hydrogen adsorbing capability. According to the present invention, the hydrogen evolving agent [or the iron powder (A)] is substantially separate from the hydrogenating catalyst metal. Therefore, the hydrogenating catalyst metal efficiently capture hydrogen evolved by the hydrogen evolving agent [or the iron powder (A)]. This is the reason why the powder mixture can treat organic chlorine compounds efficiently.

Incidentally, the above-mentioned hydrogenating catalyst metals may be used alone or in combination with one another.

The catalyst powder (B) may be a powder (B1) of the hydrogenating catalyst metal per se (or the group VIII elements in the periodic table). Alternatively, it may be a powder (B2) which is a porous material supporting the hydrogenating catalyst metal. It is possible to use the metal powder (B1) and the supporting powder (B2) in combination. The metal powder (B1) is simple in production, whereas the supporting powder (B2) can reduce the amount of the hydrogenating catalyst metal to be used.

The amounts of the metal powder (B1) and the supporting powder (B2) vary depending on their reactivity and their mixing ratio (if they are used in combination). The actual amounts can be established according to their usage. Although, it is recommended to establish the amounts based on the index K mentioned later, a general guide is given in the following.

In the case where the agent for removing organic chlorine compounds is formed from the iron powder (A) and the metal powder (B1) or from the iron powder (A) and the supporting powder (B2), the amount of each component should be as follows. In the case where the metal powder (B1) and the supporting powder (B2) are used in combination, their amount should be as follows.
(i) In the case where the agent for removing organic chlorine compounds is composed of the iron powder (A) and the metal powder (B1)
   The amount of the metal powder (B1) should be no less than 0.01 parts by mass, preferably no less than 0.05 parts by mass, and more preferably no less than 0.10 parts by mass, for 100 parts by mass of the iron powder (A). Despite its extremely small amount, the metal powder (B1) efficiently decomposes organic chlorine compounds. Although the amount of the metal powder (B1) is not specifically restricted in its upper limit, it is usually no more than 10 parts by mass, preferably no more than 8 parts by mass, and more preferably no more than 5 parts by mass, for 100 parts by mass of the iron powder (A). An excessively large amount is wasted without additional effect.
(ii) In the case where the agent for removing organic chlorine compounds is composed of the iron powder (A) and the supporting powder (B2)
   The amount of the supporting powder (B2) should be no less than 0.0001 parts by mass, preferably no less than 0.0005 parts by mass, and more preferably no less than 0.001 parts by mass, for 100 parts by mass of the iron powder (A). The amount of the supporting powder (B2) is much smaller than that of the metal powder (B1). This greatly saves the use of the hydrogenating catalyst metal, which leads to a significant cost reduction of the agent for removing organic chlorine compounds. Although the amount of the supporting powder (B2) is not specifically restricted in its upper limit, it is usually no more than 10 parts by mass, preferably no more than 1 part by mass, and more preferably no more than 0.5 parts by mass, for 100 parts by mass of the iron powder (A). An excessively large amount is wasted without additional effect.

The content of the hydrogenating catalyst metal in the supporting powder (B2) may be properly established according to the amount of the supporting powder (B2). It is usually 0.01-30 mass %, preferably 0.05-20 mass %, and more preferably 0.1-10 mass %.

The BET specific surface area of the metal powder (B1) should be no smaller than 0.05 m²/g, preferably no smaller than 0.10 m²/g, and more preferably no smaller than 0.2 m²/g. The BET specific surface area of the supporting powder (B2) should be no smaller than 4 m²/g, preferably no smaller than 50 m²/g, and more preferably no smaller than 100 m²/g. The supporting powder (B2) has a larger specific surface area than the metal powder (B1) because it is formed from a porous material. The larger the specific surface area, the higher the efficiency of hydrogen capture and the higher the efficiency of decomposition of organic chlorine compounds. The specific surface area of the catalyst powder (B) [both or either of the metal powder (B1) and the supporting powder (B2)] is not an essential requirement, because the small specific surface area can be compensated by increasing the amount of the catalyst powder (B) [both or either of the metal powder (B1) and the supporting powder (B2)] or by increasing the content of the hydrogenating catalyst metal in the supporting powder (B2). With an excessively large specific surface area, the catalyst powder (B) [both or either of the metal powder (B1) and the supporting powder (B2)] becomes readily deactivated before use due to excessively high reactivity and hence it is wasted without additional effect. Therefore, the BET specific surface area of the metal powder (B1) should be no larger than 4 m²/g, preferably no larger than 3 m²/g, and more preferably no larger than 2 m²/g. The BET specific surface area of the supporting powder (B2) should be no larger than 1000 m²/g, preferably no larger than 500 m²/g, and more preferably no larger than 300 m²/g.

The porous material is not specifically restricted in its kind. It includes, for example, aluminum-based porous materials (such as active alumina, alumina, and hydrotalcite), aluminum-silicon-based composite porous materials (such as allophane, aluminosilicate, zeolite, activated clay, and mica), silicon-based porous materials (such as silica, talc, and diatomaceous earth), and carbon-based porous materials (such as active carbon).

According to the present invention, the agent for removing organic chlorine compounds does not necessarily need to be a mixture composed of the iron powder (A) and the catalyst powder (B) [both or either of the metal powder (BB) and the supporting powder (B2)]. The iron powder (A) and the catalyst powder (B) may be supplied separately packed in bags. In this case, they may be properly mixed together at the time of use. It is even unnecessary to mix them in some cases if they are properly used to treat organic chlorine compounds (as mentioned later).

The agent for removing organic chlorine compounds, which accords with the present invention, can be used to clarify soil and/or groundwater which has been contaminated with organic chlorine compounds. It can also be used to clarify contaminated soil in situ. In this case, the agent for removing organic chlorine compounds is mixed with (or dispersed into) soil (or contaminated soil) and the resulting mixture is burred in the ground. In this way it is possible to clarify the contaminated soil by utilizing the groundwater flowing through the region. In this way it is also possible to clarify the groundwater even though the soil in the region is not contaminated.

In the case where the mixture of soil and the agent for removing organic chlorine compounds is dispersed into (or mixed with) soil, the amount of the agent for removing organic chlorine compounds may be properly established according to the degree of contamination or the density of the mixture buried. The amount of the agent for removing organic chlorine compounds is usually 1 to 50 parts by mass for 100 parts by mass of soil.

In this case, the agent for removing organic chlorine compounds should be mixed with soil in such a way that the iron powder (A) and the catalyst powder (B) are separate a proper distance away from each other, in view of the fact that it is composed of the iron powder (A) and the catalyst powder (B) [both or either of the metal powder (B1) and the supporting powder (B2)]. If the iron powder (A) and the catalyst powder (B) are in contact with each other, the local cell theory may be used to elucidate the mechanism of removing organic chlorine compounds. However, it was found that organic chlorine compounds are removed more efficiently in the case where the iron powder (A) and the catalyst powder (B) are separate from each other than in the case where the iron powder (A) and the catalyst powder (B) are in contact with each other. (See Examples given later.) A probable reason for this is that the iron powder (A) evolves hydrogen on its surface and this hydrogen migrates to the surface of the catalyst powder (B) and brings about dechlorination effectively during its migration. And the slow dechlorination is accelerated in the presence of the catalyst powder (B) capable of hydrogen adsorption.

It is important for efficient treatment to reduce the amount of hydrogen which is lost during migration from the iron powder (A) to the catalyst powder (B). To achieve this object, it is necessary to adequately separate the iron powder (A) and the catalyst powder (B) from each other as mentioned above. However, it is difficult to establish the adequate condition quantitatively. The efficiency of dechlorination depends on the amount and grain size of the iron powder (A) and the catalyst powder (B), and hence it is necessary to take these factors into account.

So, the present inventors theorized as follows to tackle this problem. They first presumed as follows paying attention to a single grain of the iron powder (A).

(i) Each grain of the iron powder (A) takes charge of each grain of soil. The soil grain is assumed to be a sphere of the same volume. This sphere is referred to as a unit soil sphere hereinafter. Now, as the surface area of the unit soil sphere increases, the loss of hydrogen increases and the efficiency of dechlorination should decrease.

(ii) As the ratio of the catalyst powder (B) contained in a unit soil sphere increases as compared with the surface area of a unit soil sphere, the loss of hydrogen should decrease and the efficiency of dechlorination should increase.

Based on the foregoing assumption, the present inventors conceived of an index which is a quotient obtained by diving the surface area of a unit soil sphere by the number of grains of the catalyst powder (B) [the metal powder (B1) and/or the supporting powder (B2)] contained in said unit soil sphere. This quotient will be referred to as the area for hydrogen passage hereinafter. The area for hydrogen passage can be represented by the formula (1) below. Area for hydrogen passage

$$Area for hydrogen passage = 4 π {R}_{A}^{2} / \{ ( {V}_{A} / {V}_{B1} ) + ( {V}_{A} / {V}_{B2} ) \} \qquad ( 1 )$$

(where, R_{A} denotes the radius (m) of a unit soil sphere; V_{A} denotes the volume (m³) of a unit soil sphere which one grain of the iron powder (A) takes charge of;
V_{B1} denotes the volume (m³) of a unit soil sphere which one grain of the metal powder (B1) takes charge of; and
V_{B2} denotes the volume (m³) of a unit soil sphere which one grain of the supporting powder (B2) takes charge of.

Incidentally, the R_{A} is obtained from the formula (2) below, because the radius R_{A} and the volume V_{A} of a unit soil sphere are related to each other by the formula V_{A}=(4/3)πR_{A}³.
R_{A}={3V_{A}/(4π)}^{1/3} (2)

The above-mentioned index “area for hydrogen passage” is related to the amount and grain size of the iron powder (A) and the catalyst powder (B). Now, let us assume a mixture composed of the following components.
100 parts by mass (or 100 tons) of soil having an apparent density of d.
x parts by mass (or x tons) of the iron powder (A) having a density of ρA and a particle diameter of D_{A}.
yB1 parts by mass (or yB1 tons) of the metal powder (B1) having a density of pB1 and a particle diameter of D_{B1}.
yB2 parts by mass (or yB2 tons) of the supporting powder (B2) having an apparent density of ρB2 and a particle diameter of D_{B2}.
   The volume of the entire iron powder (A) is expressed by x/ρA, and the volume of a single grain of the iron powder (A) is expressed by (4/3)π×(D_{A}/2)³=πD_{A}³/6. The number of particles of the iron powder (A) is calculated from [the entire volume of the iron powder (A)] divided by [the volume of a single particle of the iron powder (A)]. It is represented by (x/ρA)/(πD_{A}³/6). Therefore, the volume V_{A} of soil which one particle of the iron powder (A) takes charge of is represented by [the entire volume of soil (or 100/d)] divided by [the number of grains of the iron powder (A)]. The result is the formula (3) below. Similarly, the volume V_{B1} of soil which one grain of the metal powder (B1) takes charge of is represented by the formula (4) below, and the volume V_{B2} of soil which one grain of the supporting powder (B2) takes charge of is represented by the formula (5) below.
   V_{A}=(100/d)/{(x/ρA)/(πD_{A}³/6)} (3)
   V_{B1}=(100/d)/{(yB1/ρB1 )/(πD_{B1}³/6)} (4)
   V_{B2}=(100/d)/{(yB2/ρB2)/(πD_{B2}³/6)} (5)
   (where, d denotes the apparent density (ton/m³) of soil;
x denotes the amount (ton) of the iron powder (A) used for 100 tons of soil;
ρA denotes the density (ton/m³) of the iron powder (A);
D_{A} denotes the particle diameter (m) of the iron powder (A);
yB1 denotes the amount (ton) of the metal powder (B1) used for 100 tons of soil;
ρB1 denotes the density (ton/m³) of the metal powder (B1);
D_{B1} denotes the particle diameter (m) of the metal powder (B1);
yB2 denotes the amount (ton) of the supporting powder (B2) used for 100 tons of soil;
ρB2 denotes the density (ton/m³) of the supporting powder (B2); and
D_{B2} denotes the particle diameter (m) of the supporting powder (B2).)

It is apparent from the formulas (2) to (5) above that the area of hydrogen passage [represented by the formula (1)] is related with the amount and grain size of the iron powder (A) and the catalyst powder (B).

Incidentally, it is possible to directly measure the apparent density (d) of soil, the density (ρA) of the iron powder (A), the density (ρB1 ) of the metal powder (B1), and the apparent density (ρB2) of the supporting powder (B2). On the other hand, it is possible to obtain the diameter (D_{A}) of the iron powder (A) and the diameter (D_{B1}) of the metal powder (B1) from the BET specific surface area. The specific surface area (σA) [surface area of a unit mass] of the iron powder (A) is represented by the formula (6) below.

$$\begin{matrix}σ A = surface area \text{/} mass \\ = sA \times nA / ( vA \times ρ A \times nA ) \\ = sA / ( vA \times ρ A )\end{matrix} \qquad ( 6 )$$

where,
σA: BET specific surface area of the iron powder (A) (m²/ton)
sA: surface area of one grain of the iron powder (A) (m²)
vA: volume of one grain of the iron powder (A) (m³)
nA: number of grains of the iron powder (A)
ρA: density of the iron powder (A)

The volume (vA), the surface area (sA), and the particle diameter (D_{A}) of one grain of the iron particle (A) are related to each other by:
vA=(4/3)π(D_{A}/2)³=πD_{A}³/6 and
sA=4π(D_{A}/2)²=πD_{A}²
Substituting this for the formula (6) above and rearranging, there is obtained the formula (7) below.
D_{A}=6/(ρAσA) (7)
where,
D_{A}: diameter of the iron particle (A) (m)
ρA: density of the iron powder (A) (ton/m³)
σA: BET specific surface area of the iron powder (A) (m²/ton)

Similarly, the particle diameter of the metal powder (B1) is represented by the formula (8) below.
D_{B1}=6/(ρB1σB1) (8)
where,
D_{B1}: particle diameter of the metal powder (B1) (m)
ρB1: density of the metal powder (B1) (ton/m³)
σB1: BET specific surface area of the metal powder (B1) (m²/ton)

Consequently, if the density and BET specific surface area are measured for the iron powder (A) and the metal powder (B1), then it is possible to calculate their particle diameter. On the other hand, it is impossible to obtain the average particle diameter for the supporting powder (B2) from its specific surface area. However, it is possible to directly measure the average particle diameter (D_{B2}) (in m) by using the particle diameter distribution measuring apparatus that uses laser diffraction (which is commercially available from Shimadzu Corporation).

Several kinds of the agent for removing organic chlorine compounds were examined to see how their effect depends on the characteristics of soil [density d (ton/m³)], the characteristics of the iron powder (A) [density ρA (ton/m³) and BET specific surface area σA (m²/ton)], the characteristics of the metal powder (B1) [density ρB1 (ton/m³) and BET specific surface area σB1 (m²/ton)], the characteristics of the supporting powder B2 [particle diameter D_{B1} (m²) ], and the area for hydrogen passage (in place of their amount x, yB1, and yB2). It was found that the maximum efficiency of dechlorination is obtained when the area for hydrogen passage is in the range of 10⁻¹⁵ m² to 10⁻⁷ m². If the area for hydrogen passage is excessively large, hydrogen is not supplied to the catalyst powder (B) so efficiently as to bring about dechlorination. Conversely, if it is excessively small, dechlorination takes place but the effect of the iron powder (A) and the catalyst powder (B) levels off. This is because any attempt to reduce the grain size of the iron powder (A) and the catalyst powder (B) deteriorates their reactivity due to surface oxidation.

Thus, the decomposition reaction can be accomplished efficiently if the amounts of x, yB1, and yB2 are properly determined according to the following characteristics so that the logarithm (K) of the area for hydrogen passage, which is an index calculated from the formula (9) below, is in the range of 7 to 15.
Characteristics of soil [density d (ton/m³)]
Characteristics of the iron powder (A) [density ρA (ton/m³) and BET specific surface area σA (m²/ton)]
Characteristics of the metal powder B1 [density ρB1 (ton/³) and BET specific surface area σB1 (m²/ton)]
Characteristics of the supporting powder B2 [particle diameter D_{B1} (m²) ]
   K=−log₁₀ [4πR_{A}²/{(V_{A}/V_{B1})+(V_{A}/V_{B2})}] (9)
   This index K can be interpreted as expressing the distance between the iron powder (A) and the catalyst powder (B) in view of the fact that the index K becomes small with the decreasing number of grains of the catalyst powder (B) in a unit soil sphere which one grain of the iron powder (A) takes charge of, with other factors remaining unchanged. Therefore, this index K may occasionally be referred to as an index K for distance between the iron powder (A) and the catalyst powder (B).

In the case where the contaminated area is broad, the agent for removing organic chlorine compounds should be buried at adequate points in consideration of the flow of groundwater. This is important to save cost for clarification. Moreover, since the hydrogenating catalyst metal accounts for a large portion of the cost of the agent for removing organic chlorine compounds, it is desirable to reduce the amount of the hydrogenating catalyst metal for economical decontamination. For this reason, further improvement is necessary in the method of burying the agent for organic chlorine compounds.

According to the reaction mechanism proposed by the present inventors, organic chlorine compounds are decomposed by the hydrogenating catalyst [the powder (B)] that utilizes hydrogen evolved by the iron powder. Therefore, what is important for economical decontamination is to bury the agent for removing organic chlorine compounds in such a way that the catalyst powder (B) efficiently comes into contact with hydrogen. For example, if the agent for removing organic chlorine compounds is a powder mixture (C) composed of the iron powder (A) and the catalyst powder (B), it is recommended to use another iron powder (A′) as the hydrogen source. In this case, the powder mixture (C) and the iron powder (A′) should be buried such that the hydrogen evolved by the iron powder (A′) migrates to the powder mixture (C). Also, in the case where the iron powder (A) and the catalyst powder (B) are used separately (without mixing), they should be buried such that hydrogen readily migrates from the iron powder (A) to the catalyst powder (B).

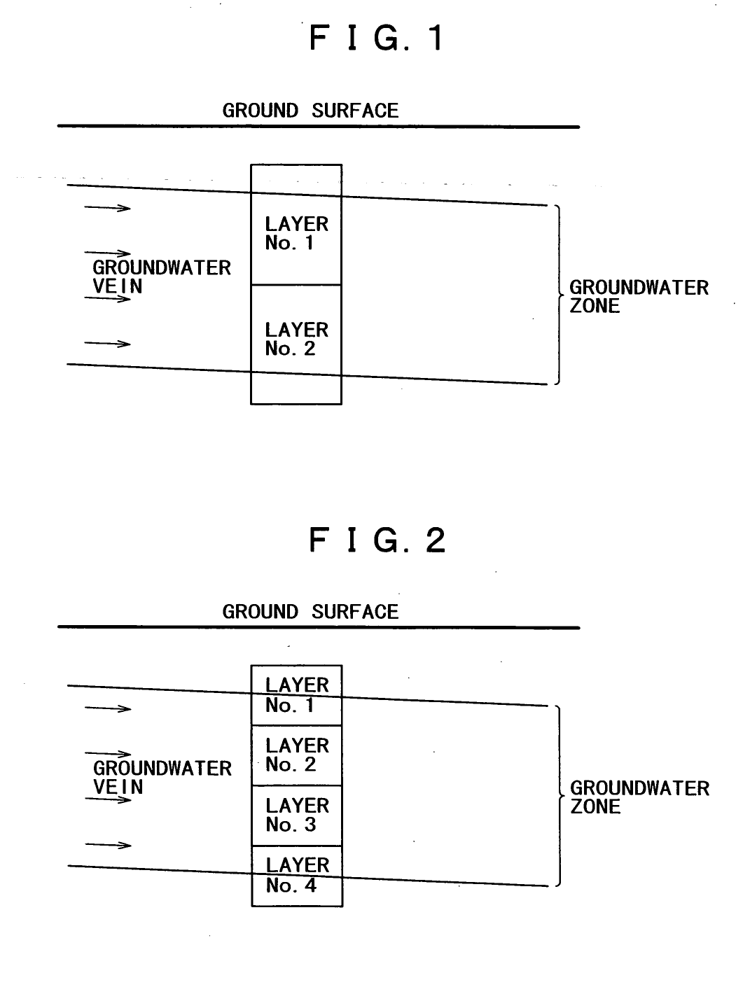

To be concrete, in the case where another iron powder (A′) and the powder mixture (C) (or the agent for removing organic chlorine compounds) are used separately in combination with each other, they should be buried in soil in the following manner. First, the region where groundwater is flowing is divided into two or more layers in the vertical direction, as shown in FIG. 1 or 2. (Layers Nos. 1 and 2 in FIG. 1, and layers Nos. 1 to 4 in FIG. 2) Soil in at least one layer under the second layer is mixed with another iron powder (A′). This layer corresponds to the layer No. 2 in FIG. 1 and the layers Nos. 2 and 4 in FIG. 2. The amount of another iron powder (A′) is 1-50 parts by mass for 100 parts by mass of soil. Then, soil in at least one layer above the layer into which the iron powder has been added is mixed with the powder mixture (C) (or the agent for removing organic chlorine compounds). This layer corresponds to layer No. 1 in FIG. 1 and the layers Nos. 1 and 3 in FIG. 2. The amount of the powder mixture (C) is 1-50 parts by mass for 100 parts by mass of soil.

It is not necessary that the layers of soil in which another iron powder (A′) and the powder mixture (C) [or the agent for removing organic chlorine compounds] are buried should be in contact with each other. However, it is desirable that they should be close to each other for better removal efficiency. It is more desirable that the layers of soil in which the iron powder (A′) and the powder mixture (C) are buried should be arranged alternately as shown in FIG. 2.

On the other hand, in the case where the iron powder (A) and the powder (B) are used separately (without mixing), the iron powder (A) is buried in the layer for another iron powder (A′) and the powder (B) is buried in the layer for the mixed powder (C).

The agent for removing organic chlorine compounds, which accords with the present invention, may also be used in such a way that it is charged into a column and contaminated groundwater is passed through the column to remove organic chlorine compounds. In this case, the powder mixture (C) composed of the iron powder (A) and the powder (B) may be used as such. However, the powder mixture (C) may also be used in combination with another iron powder (A′) as in the case of in-situ treatment. In this case, the powder mixture (C) is placed under another iron powder (A′), or the powder mixture (C) and another iron powder (A′) are placed alternately. In the case where the iron powder (A) and the powder (B) are used separately without mixing, the iron powder (A) is placed under the powder (B) or the iron powder (A) and the powder (B) are placed alternately.

### EXAMPLES

The invention will be described in more detail with reference to Examples which are not intended to restrict the scope thereof. Thus, various changes and modifications may be made in the invention without departing from the spirit and scope thereof.

### Experiment Example 1

Samples of the agent for removing organic chlorine compounds [powder mixture (C)] were prepared from various kinds of iron powder (A) and various kinds of metal powder (B1) in various ratios as shown in Tables 1 to 4.

The resulting samples were examined for performance in the following manner. First, artificially contaminated groundwater was prepared from ultrapure water and trichloroethylene (referred to as TCE hereinafter) as an organic chlorine compound. The ultrapure water was kept in an anaerobic state after it had been freed of dissolved oxygen by nitrogen aeration. TCE was added in such an amount that its concentration in water was 10 mg/L. The sample of the agent for removing organic chlorine compounds was placed in a vial (125 mL) so that its concentration was 100 g/L. The vial was completely filled with the artificially contaminated water and closed air tight. The vial was shaken at normal temperature so that the agent for removing organic chlorine compounds moved up and down and right and left. After shaking for a prescribed period of time, the concentration of TCE was determined to calculate the ratio of removal.

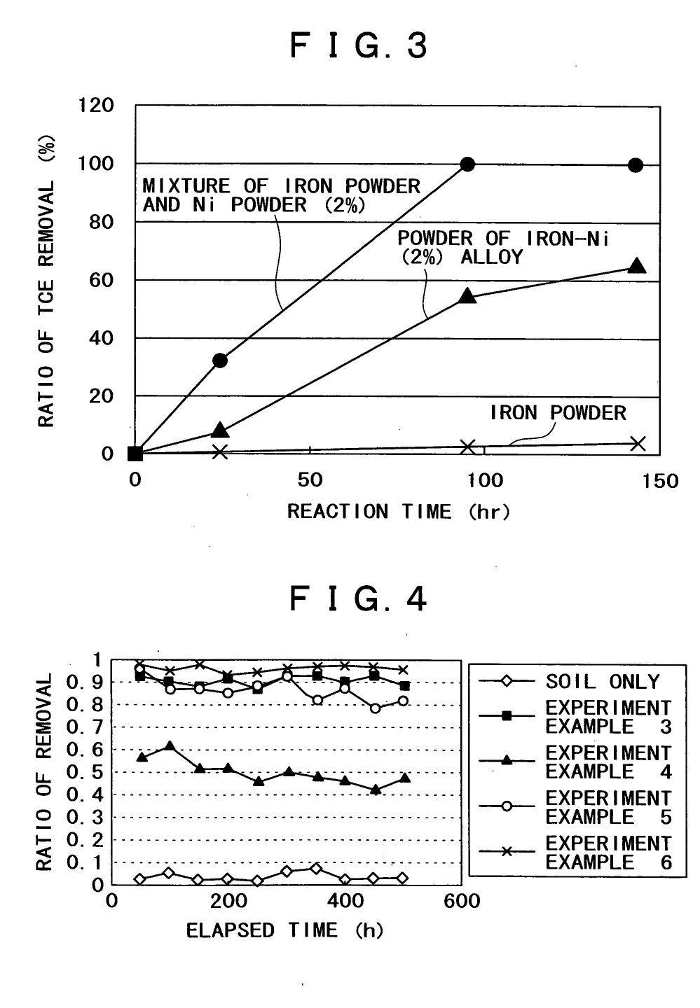

The results are shown in Tables 1 to 3. The results shown in Table 1 are graphed in FIG. 3.

TABLE 1

| | Iron powder (A) | | | Metal powder (B1) | | | Ratio of removal | | |
|---|---|---|---|---|---|---|---|---|---|
| | | BET specific | Oxygen | | BET specific | | of TCE (%) | | |
| | | surface area | content | | surface area | | After | After | After |
| No. | Kind | (m²/g) | (%) | Kind | (m²/g) | Mixing ratio* | 24 h | 96 h | 144 h |
| 1 | Atomized iron powder | 0.27 | 0.49 | Ni powder | 0.08 | 2 | 32 | 100 | 100 |

| | | | | | | | | |
|---|---|---|---|---|---|---|---|---|
| 2 | Ni-alloyed atomized | 0.204 | 0.55 | Not used | — | 8 | 55 | 66 |
| | iron powder** | | | | | | | |
| 3 | Atomized iron powder | 0.27 | 0.49 | Not used | — | 1 | 3 | 4 |

*Amount (parts by mass) of the metal powder for 100 parts by mass of the iron powder.
**Ni content = 1.82 mass %

TABLE 2

| | Iron powder (A) | | | Metal powder (B1) | | | Ratio of removal | | |
|---|---|---|---|---|---|---|---|---|---|
| | | BET specific | Oxygen | | BET specific | | of TCE (%) | | |
| | | surface area | content | | surface area | | After | After | After |
| No. | Kind | (m²/g) | (%) | Kind | (m²/g) | Mixing ratio* | 24 h | 96 h | 144 h |
| 4 | Atomized iron powder | 0.27 | 0.49 | Pd powder | 0.7 | 0.5 | 100 | 100 | 100 |
| 5 | Atomized iron powder | 0.27 | 0.49 | Rh powder | 0.4 | 0.3 | 95 | 99 | 100 |
| 6 | Atomized iron powder | 0.27 | 0.49 | Ru powder | 0.3 | 0.4 | 100 | 100 | 100 |
| 7 | Atomized iron powder | 0.27 | 0.49 | Zn powder | 0.05 | 1 | 4 | 6 | 6 |
| 8 | Atomized iron powder | 0.27 | 0.49 | Sn powder | 0.04 | 1 | 6 | 9 | 11 |
| 9 | Atomized iron powder | 0.27 | 0.49 | Pb powder | 0.05 | 1 | 0 | 1 | 9 |

*Amount (parts by mass) of the metal powder for 100 parts by mass of the iron powder.

TABLE 3

| | Iron powder (A) | | | Metal powder (B1) | | | Ratio of removal | | |
|---|---|---|---|---|---|---|---|---|---|
| | | BET specific | Oxygen | | BET specific | | of TCE (%) | | |
| | | surface area | content | | surface area | | After | After | After |
| No. | Kind | (m²/g) | (%) | Kind | (m²/g) | Mixing ratio* | 24 h | 96 h | 144 h |
| 10 | Pure iron powder | 0.23 | 0.57 | Ni powder | 0.08 | 2 | 26 | 86 | 96 |
| 11 | Cast iron powder | 1.14 | 1.23 | Ni powder | 0.08 | 2 | 71 | 80 | 90 |
| 12 | Mn-alloyed iron powder** | 0.21 | 0.46 | Ni powder | 0.08 | 2 | 17 | 82 | 94 |
| 13 | Ni-alloyed atomized | 0.204 | 0.55 | Ni powder | 0.08 | 2 | 27 | 84 | 100 |
| | powder*** | | | | | | | | |
| 14 | Atomized iron powder | 0.008 | 0.5 | Ni powder | 0.08 | 2 | 12 | 17 | 20 |
| 15 | Steel chip blast powder | 1.13 | 23.9 | Ni powder | 0.08 | 2 | 17 | 14 | 19 |
| 16 | Converter coarse dust | 3 | 6.56 | Ni powder | 0.08 | 2 | 3 | 6 | 14 |
| 17 | Atomized iron powder | 0.27 | 0.49 | Ni powder | 0.08 | 0.008 | 5 | 8 | 11 |
| 18 | Atomized iron powder | 0.27 | 0.49 | Ni powder | 0.006 | 15 | 16 | 24 | 32 |

*Amount (parts by mass) of the metal powder for 100 parts by mass of the iron powder.
**Mn content = 0.94 mass %
***Ni content = 1.82 mass %

It is apparent from Table 1 and FIG. 3 that sample No. 1 (which is a mixture of iron powder and 2% Ni powder) is by far superior in TCE removal to sample No. 2 (which is a powder of an alloy of iron and 2% Ni). This suggests that TCE removal by hydrogen (as proposed by the present inventors) is superior to that by the local cell mechanism. Incidentally, the iron powder was examined for oxidation before and after reactions. The results are shown in Table 4. It is noted from Table 4 that the powder of iron-nickel alloy is less subject to oxidation than the mixed powder of iron and nickel. This supports that the mixed powder exhibits better performance than the alloy powder.

It is apparent from Table 2 that the metal powder (B1) should be a hydrogenating catalyst metal (Pd, Rh, or Ru in Examples shown in Table 2) which is one of the group VIII elements (excluding iron) in the periodic table.

The last five samples shown in Table 4 are poor in the effect of TCE removal because of the following defects.
Sample No. 14: the iron powder has an excessively small BET specific surface area.
Samples Nos. 15 and 16: the iron powder contains an excessively large amount of oxygen.
Sample No. 17: the amount of the metal powder (B1) is excessively small.
Sample No. 18: the metal powder (B1) has an excessively small BET specific surface area.

Nevertheless, as shown in FIG. 3, they are still superior to alloy powder (for the local cell mechanism) under the same condition. They will fully produce the desired effect under the optimum condition specified for Samples Nos. 10 to 13.

TABLE 4

| | | Amount of Fe and Fe₂O₃ | |
|---|---|---|---|
| | | after experiment | |
| Kind | Amount of Ni | Fe | Fe₂O₃ |
| Fe—Ni mixed powder | 2.02 mass % | 92.8 mass % | 4.6 mass % |
| (No. 1 in Table 1) | | | |
| Fe—Ni alloy powder | 1.82 mass % | 96.5 mass % | 1.9 mass % |
| (No. 2 in Table 1) | | | |

### Experiment Example 2

The same procedure as in Experiment Example 1 was repeated except that the metal powder (B1) was replaced by any one of various supporting powders (B2). The results are shown in Table 5.

TABLE 5

| | Iron powder (A) | | | Metal powder (B1) | | | Ratio of removal | | |
|---|---|---|---|---|---|---|---|---|---|
| | | BET specific | Oxygen | | BET specific | | of TCE (%) | | |
| | | surface area | content | | surface area | | After | After | After |
| No. | Kind | (m²/g) | (%) | Kind | (m²/g) | Mixing ratio* | 24 h | 96 h | 144 h |
| 19 | Atomized iron powder | 0.27 | 0.49 | Ni/active alumina | 157 | 0.05 | 84 | 98 | 100 |
| | | | | (Ni = 5 mass %) | | | | | |
| 20 | Atomized iron powder | 0.27 | 0.49 | Pd/active alumina | 157 | 0.05 | 99 | 100 | 100 |
| | | | | (Pd = 5 mass %) | | | | | |
| 21 | Atomized iron powder | 0.27 | 0.49 | Pt/active alumina | 157 | 0.05 | 65 | 92 | 98 |
| | | | | Pt = 5 mass % | | | | | |
| 22 | Atomized iron powder | 0.27 | 0.49 | Ru/active alumina | 157 | 0.05 | 64 | 89 | 99 |
| | | | | (Ru = 5 mass %) | | | | | |
| 23 | Atomized iron powder | 0.27 | 0.49 | Pd/active alumina | 157 | 0.002 | 45 | 74 | 95 |
| | | | | (Pd = 0.2 mass %) | | | | | |
| 24 | Atomized iron powder | 0.27 | 0.49 | Pd/diatomaceous earth | 21 | 0.002 | 35 | 65 | 90 |
| | | | | (Pd = 0.2 mass %) | | | | | |
| 25 | Atomized iron powder | 0.27 | 0.49 | Pd/silica gel | 189 | 0.002 | 54 | 87 | 99 |
| | | | | (Pd = 0.2 mass %) | | | | | |
| 26 | Atomized iron powder | 0.27 | 0.49 | Ni/active alumina | 157 | 0.00005 | 3 | 5 | 13 |
| | | | | (Ni = 0.5 mass %) | | | | | |
| 27 | Atomized iron powder | 0.27 | 0.49 | Ni/diatomaceous earth | 1.2 | 0.002 | 4 | 12 | 20 |
| | | | | (Ni = 0.2 mass %) | | | | | |

*Amount (parts by mass) of the supporting powder for 100 parts by mass of the iron powder.

It is apparent from Table 5 that the supporting powder (B2) reduces the amount of the hydrogenating catalyst metal more than the metal powder (B1).

### Experiment Examples 3 to 6

Silica sand No. 4 (as a model of soil) was mixed with the sample No. 1 (as the agent for removing organic chlorine compounds) mentioned above, which is a mixture of the iron powder (A) and the metal powder (B1). The amount of the agent was 100 g for 1 kg of silica sand. This mixture is designated as soil (A).

Silica sand No. 4 (as a model of soil) was mixed with an iron powder (A′), which is equivalent to the iron powder (A) as the sample No. 1 mentioned above. The amount of the iron powder was 100 g for 1 kg of silica sand. This mixture is designated as soil (B).

Artificially contaminated water was prepared in the same way as in Experiment Example 1, except that the concentration of TCE was changed to 1 mg/L.

In Experiment Example 3, soil (A) was charged into a glass column (30 mm in diameter; the same shall apply hereinafter) so that the layer thickness was 40 cm. (In other words, soil (A) constitutes a single layer.) In Experiment Example 4, soil (B) was charged into a glass column so that the layer thickness was 40 cm. (In other words, soil (B) constitutes a single layer.) In Experiment Example 5, soil (B) was charged into a glass column so that the layer thickness was 20 cm from the bottom, and then soil (A) was charged into the same column as above so that the layer thickness was 20 cm from the top of the first layer. (In other words, soil (B) and soil (A) constitute two layers.) In Experiment Example 6, soil (B) was charged into a glass column so that the layer thickness was 7 cm from the bottom, and then soil (A) was charged into the same column as above so that the layer thickness was 3 cm from the top of the first layer. This procedure was repeated three times until the total layer thickness reached 40 cm. (In other words, the column contains eight layers made up of soil B, soil A, soil B, soil A, soil B, soil A, soil B, and soil A, which are placed sequentially one over the other.)

The artificially contaminated water was passed through each of the glass columns (at a flow rate of 40 mL/h so that the contact time was 7 hours). The concentration of TCE was measured at the exit of the column. The change with time of the ratio of TCE removal was calculated from the formula below.
Ratio of TCE removal=[1−C/C₀]×100
where, C₀ denotes the concentration of TCE at the entrance of the column and C denotes the concentration of TCE at the exit of the column.

The results are shown in FIG. 4.

It is apparent from FIG. 4 that the results in Experiment Examples 3, 5, and 6, in which the agent for removing organic chlorine compounds is a mixture of the iron powder (A) and the metal powder (B1), are superior in removal of TCE to the results in Experiment Example 4, in which the iron powder (A′) was used alone. The results in Experiment Examples 5 and 6, in which the agent for removing organic chlorine compounds was placed over the iron powder (A′), are superior in removal of TCE to the results in Experiment Example 3, in which the agent for removing organic chlorine compounds was used alone.

### Experiment Example 7

Various kinds of agents for removing organic chlorine compounds were examined to see how the separation index K (defined below) varies depending on the characteristics of soil [density d (ton/m³)], the characteristics of the iron powder (A) [density ρA (ton/m³) and BET specific surface area σA (m²/ton)], the characteristics of the nickel powder B1 [density ρB1 (ton/³) and BET specific surface area δB1 (m²/ton)], and their amounts x and yB1.
K=−log₁₀ [4πR_{A}²/{(V_{A}/V_{B1} )+(V_{A}/V_{B2})}]

The results are shown in Table 6.

TABLE 6

| | Agent for removing organic chlorine compounds | | | | | | | | | | |
|---|---|---|---|---|---|---|---|---|---|---|---|
| | Iron powder | | | | | | | | | | |
| | | | | | | Radius | | | | | |
| | | | | | Volume | of soil | | | | | Volume |
| | | | | | of one | sphere | | | | | of one |
| | | | | Particle | grain of | of one | | | | Particle | grain of |
| | | | | diameter *4 | soil *5 | grain *6 | | | | diameter *10 | soil *11 |
| Name | Amount *1 | Density *2 | BET *3 | Calcd. | Calcd. | Calcd. | Amount *7 | Density *8 | BET *9 | Calcd. | Calcd. |
| Fe—Ni | 10 | 7.9 | 76900 | 9.9E−06 | 2.0E−14 | 1.7E−05 | 1 | 10 | 500000 | 1.2E−06 | 4.5E−16 |
| mixture | 10 | 7.9 | 924600 | 8.2E−07 | 1.1E−17 | 1.4E−06 | 1 | 10 | 500000 | 1.2E−06 | 4.5E−16 |
| (Ni = 10%) | | | | | | | | | | | |
| Fe—Ni | 10 | 7.9 | 270000 | 2.8E−06 | 4.6E−16 | 4.8E−06 | 0.2 | 10 | 500000 | 1.2E−06 | 2.3E−15 |
| mixture | 5 | 7.9 | 270000 | 2.8E−06 | 9.2E−16 | 6.0E−06 | 0.1 | 10 | 500000 | 1.2E−06 | 4.5E−15 |
| (Ni = 2%) | 2 | 7.9 | 270000 | 2.8E−06 | 2.3E−15 | 8.2E−06 | 0.04 | 10 | 500000 | 1.2E−06 | 1.1E−14 |
| | 0.5 | 7.9 | 270000 | 2.8E−06 | 9.2E−15 | 1.3E−05 | 0.01 | 10 | 500000 | 1.2E−06 | 4.5E−14 |
| Fe—Ni | 10 | 7.9 | 270000 | 2.8E−06 | 4.6E−16 | 4.8E−06 | 0.1 | 10 | 500000 | 1.2E−06 | 4.5E−15 |
| mixture | 5 | 7.9 | 270000 | 2.8E−06 | 9.2E−16 | 6.0E−06 | 0.05 | 10 | 500000 | 1.2E−06 | 9.0E−15 |
| (Ni = 1%) | 2 | 7.9 | 270000 | 2.8E−06 | 2.3E−15 | 8.2E−06 | 0.02 | 10 | 500000 | 1.2E−06 | 2.3E−14 |
| | 0.5 | 7.9 | 270000 | 2.8E−06 | 9.2E−15 | 1.3E−05 | 0.005 | 10 | 500000 | 1.2E−06 | 9.0E−14 |

| | | Area for | | |
|---|---|---|---|---|
| | Soil | hydrogen | Separation | Efficiency |
| | Apparent | passage *13 | index K | of |
| Name | density *12 | Calcd. | Calcd. | removal |
| Fe—Ni | 2 | 8.1E−11 | 10.1 | Good |
| mixture | 2 | 9.7E−10 | 9.0 | Good |
| (Ni = 10%) | | | | |
| Fe—Ni | 2 | 1.4E−09 | 8.8 | Good |
| mixture | 2 | 2.2E−09 | 8.6 | Good |
| (Ni = 2%) | 2 | 4.1E−09 | 8.4 | Good |
| | 2 | 1.0E−08 | 8.0 | Good |
| Fe—Ni | 2 | 2.8E−09 | 8.5 | Good |
| mixture | 2 | 4.5E−09 | 8.3 | Good |
| (Ni = 1%) | 2 | 8.3E−09 | 8.1 | Good |
| | 2 | 2.1E−08 | 7.7 | Good |

*1: x (ton/100 tons of soil),
*2: ρA (ton/m³),
*3: σA (m²/ton),
*4: D_{A} (m),
*5: V_{A} (m³),
*6: R_{A} (m),
*7: yB1 (ton/100 tons of soil),
*8: ρB1 (ton/m³),
*9: σB1 (m²/ton),
*10: DB1 (m),
*11: VB1 (m³),
*12: d (ton/m³),
*13: (m²)

It is apparent from Table 6 that the separation index K should be adequately established so as to achieve dechlorination more efficiently.

1. An agent for removing organic chlorine compounds which comprises mixed together:
(A) an iron powder having a BET specific surface area of from 0.010 to 3 m²/g, and
(B1) a powder of at least one species of metal selected from the group VIII elements (excluding Fe) in the periodic table, and/or
(B2) a porous substance in powder form supporting said metal.

2. The agent for removing organic chlorine compounds as defined in claim 1, which comprises the iron powder (A) and the metal powder (B1), with the amount of the metal powder (B1) being from 0.01 to 10 parts by mass for 100 parts by mass of the iron powder (A).

3. The agent for removing organic chlorine compounds as defined in claim 1, wherein the metal powder (B1) has a BET specific surface area ranging from 0.05 to 4 m²/g.

4. The agent for removing organic chlorine compounds as defined in claim 1, which comprises the iron powder (A) and the supporting powder (B2), with the amount of the supporting powder (B2) being from 0.0001 to 10 parts by mass for 100 parts by mass of the iron powder (A).

5. The agent for removing organic chlorine compounds as defined in claim 1, wherein the supporting powder (B2) contains the group VIII elements (excluding Fe) in an amount of 0.01 to 30 mass %.

6. The agent for removing organic chlorine compounds as defined in claim 1, wherein the supporting powder (B2) has a BET specific surface area ranging from 4 to 1000 m²/g.

7. The agent for removing organic chlorine compounds as defined in claim 1, wherein the porous substance is at least one species selected from alumina, hydrotalcite, allophane, aluminosilicate, zeolite, activated clay, mica, silica, talc, diatomaceous earth, and active carbon.

8. The agent for removing organic chlorine compounds as defined in claim 1, wherein the powder (B1 and B2) is at least one species selected from Ni, Ru, Rh, Pd, and Pt.

9. The agent for removing organic chlorine compounds as defined in claim 1, wherein the iron powder contains oxygen in an amount no more than 5 mass %.

10. A method for removing organic chlorine compounds from groundwater and/or soil, which comprises mixing 100 parts by mass of soil with 1 to 50 parts by mass of the agent for removing organic chlorine compounds defined in claim 1 and subsequently bringing the mixture into contact with groundwater.

11. An agent for removing organic chlorine compounds which comprises an iron powder (A) having a BET specific surface area of 0.010 to 3 m²/g and a powder (B1) of at least one species of metal selected from the group VIII elements (excluding Fe) in the periodic table and/or a powder (B2) which is a porous substance supporting said metal.

12. The method as defined in claim 10, wherein soil is mixed with the agent for removing organic chlorine compounds in such a way that the iron powder (A) is a certain distance away from the powders (B1 and B2) such that the separation index K (represented by the formula below) is from 7 to 15.
K=−log₁₀ [4πR_{A}²/{(V_{A}/V_{B1})+(V_{A}/V_{B2})}]
(where, R_{A}, V_{A}, V_{B1}, and V_{B2} stand for the following.
R_{A}: the radius (m) of the soil regarded as a sphere with which one grain of the iron powder (A) is involved.
V_{A}: the volume (m³) of the soil with which one grain of the iron powder (A) is involved.
V_{B1}: the volume (m³) of the soil with which one grain of the metal powder (B1) is involved.
V_{B2}: the volume (m³) of the soil with which one grain of the metal powder (B2) is involved.)
Incidentally, the R_{A} is obtained from the formula below.
R_{A}={3V_{A}/(4π)}^{1/3}
where, V_{A}, V_{B1}, and V_{B2} are calculated from the following formulas.
V_{A}=(100/d)/{(x/ρA)/(πD_{A}³/6)}
V_{B1}=(100/d)/{(yB1/ρB1)/(πD_{B1}³/6)}
V_{B2}=(100/d)/{(yB2/ρB2)/(πD_{B2}³/6)}
where,
d: the apparent density (ton/m³) of soil.
x: the amount (ton) of the iron powder (A) used for 100 tons of soil.
ρA: the density (ton/m³) of the iron powder (A).
D_{A}: the particle diameter (m) of the iron powder (A).
yB1: the amount (ton) of the metal powder (B1) used for 100 tons of soil.
ρB1: the density (ton/m³) of the metal powder (B1).
D_{B1}: the particle diameter (m) of the metal powder (B1).
yB2: the amount (ton) of the supporting powder (B2) used for 100 tons of soil.
ρB2: the density (ton/m³) of the supporting powder (B2).
D_{B2}: the particle diameter (m) of the supporting powder (B2).
where, the values of d, ρA, ρB1, and ρB2 can be obtained by direct measurements of soil and powders; the value of D_{B2} can be obtained directly by measurement of the supporting powder (B2) with an apparatus for measuring particle size distribution by laser diffraction; the values of D_{A} and D_{B1} can be obtained from the formula below by measurement of the BET specific surface area of the respective powders; and the values of x, yB1, and yB2 are adjusted so that the separation factor K takes a value from 7 to 15.
D_{A}=6/(ρA σA)
D_{B1}=6/(ρB1δB1)
where,
σA: the BET specific surface area (m²/ton) of the iron powder (A).
σB1: the BET specific surface area (m²/ton) of the metal powder (B1).

13. A method for decomposing and removing organic chlorine compounds contained in groundwater and/or soil by in-situ treatment of contaminated soil in which groundwater is flowing, said method comprising a first step of dividing part of the region in which groundwater is flowing into two or more layers in the vertical direction, a second step of mixing 1 to 50 parts by mass of an iron powder with 100 parts by mass of soil in at least one layer under the second layer (from above) of the divided layers, and a third step of mixing 1 to 50 parts by mass of the agent for removing organic chlorine compound as defined in claim 1 with 100 parts by mass of soil in at least one layer above the layer in which the iron powder has been mixed with soil.

14. The method for decomposing and removing organic chlorine compounds contained in groundwater and/or soil as defined in claim 13, which comprises forming layers alternately such that 1 to 50 parts by mass of an iron powder is mixed with 100 parts by mass of soil in one layer and 1 to 50 parts by mass of the agent for removing organic chlorine compound as defined in claim 1 is mixed with 100 parts by mass of soil in another layer.

15. A method for decomposing and removing organic chlorine compounds contained in groundwater and/or soil by in-situ treatment of contaminated soil in which groundwater is flowing, said method comprising a first step of dividing part of the region in which groundwater is flowing into two or more layers in the vertical direction, a second step of applying the iron powder (A) defined in claim 11 to soil in at least one layer under the second layer (from above) of the divided layers, and a third step of applying the metal powder (B1) and/or the supporting powder (B2) defined in claim 11 to soil in at least one layer above the layer in which the iron powder (A) has been applied to soil.

16. A method for decomposing and removing organic chlorine compounds contained in groundwater and/or soil, said method comprising bringing a mixture into contact with groundwater, said mixture being composed of 100 parts by mass of soil and 1 to 50 parts by mass of the agent for removing organic chlorine compounds as defined in claim 11.
